(19) United States
(12) Patent Application Publication
(10) Pub. No.: US 2013/0247620 A1
(43) Pub. Date: Sep. 26, 2013

(54) SILICON REFINING DEVICE AND SILICON REFINING METHOD

(71) Applicant: ULVAC, Inc., Chigasaki-shi (JP)

(72) Inventor: Yasuo OOKUBO, Tomisato-shi (JP)

(73) Assignee: ULVAC, Inc., Chigasaki-shi (JP)

(21) Appl. No.: 13/903,321

(22) Filed: May 28, 2013

Related U.S. Application Data
(63) Continuation of application No. PCT/JP2011/077346, filed on Nov. 28, 2011.

(30) Foreign Application Priority Data
Nov. 29, 2010 (JP) 2010-264874

(51) Int. Cl. C01B 33/037

(52) U.S. Cl. CPC C01B 33/037
USPC 65/134.2; 65/348

(57) ABSTRACT

A technology for removing impurities from a silicon raw material at a low cost. A base material made of metallurgical silicon is arranged in a dissolution vessel, the base material arranged in the dissolution vessel is heated in a vacuum ambience and fully molten, silicon is solidified from a portion where an inner bottom surface of the dissolution vessel is in contact with molten silicon by cooling the outer bottom surface of the dissolution vessel in a state where the outer bottom surface faces the cooling means, spaced from the cooling means, the solidificated silicon is made to grow upward, and unsolidificated silicon located above the solidificated silicon is removed from the dissolution vessel.

### TECHNICAL FIELD

The present invention generally relates to a silicon refining device and a silicon refining method.

### BACKGROUND ART

In silicon used for a solar cell, a large number of impurity elements need to be reduced to the order of ppm. Thus, metal silicon as a starting material is refined separately in processes for removing boron, phosphorous, and other metal elements. Elements such as iron, aluminum, calcium or the like in the impurity elements are removed and refined by directional solidification process due to their low segregation coefficients.

In order to conduct the directional solidification, solidification at a constant speed upward from a bottom part of silicon molten metal is needed. Thus, the molten metal was heated from above, while a bottom surface of a crucible was cooled.

If this method is used, since the crucible bottom part is cooled, solidification progresses in a stable manner at a relatively fast solidification speed from a lower part of the silicon molten metal. However, if heat removal at the crucible bottom part is too strong, an undissolved part (scull) is generated in a contact portion between the crucible bottom surface and the molten silicon during silicon dissolving; the part remains at the impurity concentration of the material silicon; and as a result, it was found that refining is insufficient.

### PRIOR-ART REFERENCES

### Patent Document

[Patent Document 1] Japanese Patent Laid-Open No. 11-199216

### DISCLOSURE OF THE INVENTION

### Problems to be Solved by the Invention

The present invention was made in order to solve the above-described disadvantages of prior-art technologies and has an object to provide a technology of removing impurities from a silicon material at a low cost.

### Means for Solving the Problems

In order to solve the above problems, the present invention is a silicon refining device comprising: a vacuum chamber; cooling means arranged in the vacuum chamber; a dissolution vessel arranged in the vacuum chamber, spaced from the cooling means; and heating means for melting silicon in the dissolution vessel.

The present invention is a silicon refining device further comprising: a supporting member for holding the dissolution vessel on the cooling means, wherein an opening portion is provided in the supporting member so that an outer bottom surface of the dissolution vessel faces the surface of the cooling means.

The present invention is a silicon refining device wherein an area ratio of a section in parallel with the inner bottom surface of the opening portion to an inner bottom surface of the dissolution vessel is at least 50%.

The present invention is a silicon refining device wherein a first insulating material is provided between the supporting member and the dissolution vessel.

The present invention is a silicon refining device wherein a second insulating material is provided on the opening portion.

The present invention is a silicon refining device wherein the first insulating material and the second insulating material are composed of carbon felt, respectively.

The present invention is a silicon refining method comprising the steps of: arranging a base material composed of metal silicon in a dissolution vessel; heating the base material arranged in the dissolution vessel in a vacuum ambience and fully melting the same; cooling a bottom surface of the dissolution vessel and solidification the silicon from a portion where an inner bottom surface of the dissolution vessel is in contact with molten silicon; crystallizing upward; and removing unsolidified silicon located above the solidified silicon from the dissolution vessel, wherein, when the bottom surface of the dissolution vessel is to be cooled, cooling an outer bottom surface of the dissolution vessel which is spaced from and facing the cooling means.

The present invention is a silicon refining method wherein, when the bottom surface of the dissolution vessel is to be cooled, a second insulating material in contact with both the outer bottom surface of the dissolution vessel and the surface of the cooling means is arranged between the outer bottom surface of the dissolution vessel and the cooling means.

### Effect of the Invention

Since heat removal efficiency of the dissolution vessel bottom surface is suppressed and scull is not generated in a portion in contact with the inner bottom surface of the dissolution vessel, in this invention, refining without refining unevenness can be achieved.

By providing the cooling means facing the outer bottom surface of the dissolution vessel, heat is efficiently removed from the bottom surface, and temperature gradient of the solid-liquid interface can be increased.

By insulating portions other than the bottom surface in the dissolution vessel, electron beam outputs can be reduced to at most 50% as compared with water-cooling copper crucibles.

Since a lowering mechanism for the cooling means is unnecessary, a device structure can be simplified.

By removing a portion where impurities cohered in a liquid state, cutting of an ingot is no longer necessary, and the silicon refining cost can be reduced.

### BRIEF DESCRIPTION OF THE DRAWINGS

FIG. 1 is an internal configuration diagram of a silicon refining device of the present invention.

FIG. 2 is a diagram for explaining a second example for the structural arrangement of a dissolution vessel and cooling means.

FIG. 3 is a diagram for explaining the structural arrangement of a second insulating material.

FIG. 4 is a diagram for explaining the structural arrangement of a third insulating material.

FIG. 5 is a diagram for explaining an area ratio of a sectional area in parallel with an inner bottom surface of an opening portion to an area of the inner bottom surface of the dissolution vessel.

FIG. 6 is a diagram for explaining the second example of the shape of a facing space.

### BEST MODES FOR CARRYING OUT THE INVENTION

Reference numeral 10 in FIG. 1 denotes a silicon refining device of the present invention.

This silicon refining device 10 has a vacuum chamber 11. Cooling means 21 is arranged inside the vacuum chamber 11; and a dissolution vessel 31 is arranged above the cooling means 21 and spaced from the cooling means 21.

Here, the dissolution vessel 31 is formed by a carbon material (graphite, for example).

An outer bottom surface of the dissolution vessel 31 and the upward-oriented surface of the cooling means 21 are flat and made parallel with each other. In the outer surface of the dissolution vessel 31, nothing is arranged between a region having a predetermined size including the center of the outer bottom surface and the surface of the cooling means 21, and a region including at least the center of the outer bottom surface is made to face the surface of the cooling means 21.

The cooling means 21 is made of copper or stainless. In the cooling means 21, a circulation path 23 for a cooling medium is arranged, and by operating a cooling device 25 provided outside the vacuum chamber 11 and by having cooled cooling medium flow into the cooling means 21, the bottom surface of the dissolution vessel 31 facing the cooling means 21 is cooled.

To the vacuum chamber 11, an evacuating device 13 is connected and the inside is evacuated and maintained in a vacuum ambience.

In the vacuum chamber 11, heating means 12 for melting silicon in the dissolution vessel 31 is provided. The heating means 12 is an electron gun, but it is not limited to an electron gun as long as the silicon in the dissolution vessel 31 can be melted, and it may be an induction heating means.

A silicon raw material, which is a base material constituted by chunk-shaped or small-flake shaped metallurgical silicon, is arranged inside the dissolution vessel 31; an electron beam is irradiated to the silicon raw material so as to melt all the silicon raw material in the dissolution vessel 31; and the inside of the dissolution vessel 31 is filled with the molten silicon. The silicon is in contact only with the carbon material of the dissolution vessel 31.

The electron beam is irradiated to the silicon while evacuating the inside of the vacuum chamber 11; and impurities with a vapor pressure higher than that of the silicon contained in the silicon raw material is evaporated and discharged to the outside of the vacuum chamber 11 by the evacuation process. More particularly, phosphorous contained in the silicon raw material is evaporated and removed, and molten silicon is refined to high purity.

If the cooling medium is made to flow inside the cooling means 21 and power of the electron beam (irradiation density) is gradually weakened without changing an irradiation width (surface) in a state where the bottom surface of the dissolution vessel 31 is cooled, silicon starts to solidify at a portion in contact with the surface of the inner bottom surface of the dissolution vessel 31, and solidified silicon grows from the lower part to the upper part. Unsolidified silicon which is molten silicon is located above the solidified silicon.

Elements (such as, Fe and Al) having low-segregation coefficients are discharged from a solid phase to a liquid phase when silicon is solidified; and thus, a concentration difference of impurities is generated between the solid phase and the liquid phase (the impurity concentration in the liquid phase is higher than the impurity concentration in the solid phase).

Therefore, if the molten silicon in the dissolution vessel 31 is cooled on a vertically lower side of the dissolution vessel 31 and the solidification of the molten silicon is made to progress from the vertically lower side to the upper side, the impurity concentration in the molten silicon located above the solidified portion gradually rises.

In the dissolution vessel 31, a tilting device 39 is provided.

In this embodiment, when the unsolidified silicon decreases to 20% of the total, while the irradiation of the electron beam is stopped, the dissolution vessel 31 is tilted by the tilting device 39, and a molten portion flows out of the dissolution vessel 31 and is received and recovered by a recovering vessel 14 arranged in the vacuum chamber 11.

Alternatively, it may be so configured that the entire molten silicon is solidified from the lower part to the upper part once and then, the electron beam is irradiated again to the solidified silicon, a portion corresponding to 20% of the whole from the upper part is melted again, the irradiation of the electron beam is stopped, and the dissolution vessel 31 is tilted by the tilting device 39 so that the re-molten portion flows out towards the outside, and the molten silicon that flows out is received and recovered by the recovering vessel 14.

In the above-described embodiment, the unsolidified silicon is recovered when the unsolidified silicon decreases to 20% of the total, but the ratio of the unsolidified silicon when being recovered is not limited to the 20% of the total but may be determined in advance depending on the purity of the raw material.

Subsequently, the heating means (electron gun) 12 is re-operated so as to irradiate the electron beam to the solidified silicon, and the solidified silicon is melted.

After the solidified silicon in the dissolution vessel 31 is fully melted, while continuing to cool the bottom surface of the dissolution vessel 31 by the cooling means 21, gradually weakening the power of the electron beam without changing the irradiation width (surface), solidifying the silicon from the portion in contact with the inner bottom surface of the dissolution vessel 31, and making to grow the solidified silicon from the portion in contact with the inner bottom surface of the dissolution vessel 31 to the upper part.

When the unsolidified silicon located at the upper part decreases to 20% of the silicon in the dissolution vessel 31 in this embodiment, the irradiation of the electron beam is stopped and the dissolution vessel 31 is tilted by the tilting device 39, the unsolidified silicon located above the solidified silicon is made to flow out towards the outside of the dissolution vessel 31, and the molten silicon that flows out is received and recovered by the recovery vessel 14.

Alternatively, after the entire molten silicon is solidified from the lower part to the upper part once, the electron beam is irradiated to the solidified silicon so as to re-dissolve the portion corresponding to 20% of the total from the upper part, the irradiation of the electron beam is stopped, the dissolution vessel 31 is tilted by the tilting device 39 so as to have the re-molten portion flow to the outside, and the molten silicon that flows out is received and recovered by the recovery vessel 14.

In the above-described embodiment, the unsolidified silicon is recovered when the unsolidified silicon decreases to 20% of the total, but the ratio of the unsolidified silicon when being recovered is not limited to 20% of the total but may be determined in advance depending on purity of the raw material.

As described above, by repeating the processes of melting the base material made of metallurgical silicon, growing the solidified silicon from the portion in contact with the inner bottom surface of the dissolution vessel 31, and removing the unsolidified silicon located above the solidified silicon in which the impurities are concentrated, the impurities in the solidified silicon can be reduced since the impurities are contained in the removed molten silicon.

The silicon refining device 10 of the present invention has a supporting member 33 for holding the dissolution vessel 31 on the cooling means 21, and an opening portion 29 is provided on the supporting member 33 so that the outer bottom surface of the dissolution vessel 31 and the upward-oriented surface of the cooling means 21 are facing each other.

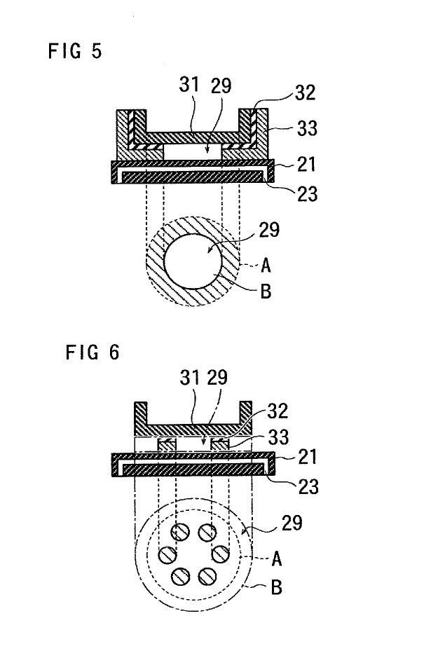

As long as the outer bottom surface of the dissolution vessel 31 and the surface of the cooling means 21 are facing each other, the opening portion 29 is not limited to a region where an outline of the outer periphery is closed by the supporting member 33 (see, FIG. 5) but may be in a region where the outline of the outer periphery is open (see, FIG. 6).

In other words, by referring to a region located inside the outer periphery of the outer bottom surface of the dissolution vessel 31 in a space between the dissolution vessel 31 and the cooling means 21 as a facing space, the opening portion 29 is constituted by a portion in the facing space other than the supporting member 33.

In this embodiment, the dissolution vessel 31 is arranged on the cooling means 21 when the first insulating material 32 is brought into contact with the outer peripheral portion or the bottom surface portion of the outer surface (that is, the outer side surfaces or outer bottom surface) and the portion with which the first insulating material 32 is brought into contact is supported by the holding tool (supporting member) 33, and the dissolution vessel 31 and the cooling means 21 are in a non-contact state. The first insulating material 32 herein is carbon felt.

If the holding tool (supporting member) 33 and the dissolution vessel 31 are in contact with each other, since the contact surface can be easily cooled, solidification from the inner peripheral surface (inner side surface) of the dissolution vessel 31 can easily occur; and thus, favorable solidification from the bottom surface toward the upper surface of the dissolution vessel 31 is obstructed. Accordingly, in this embodiment, the cooling is suppressed by placing the first insulating material 32 between the holding tool (supporting member) 33 and the dissolution vessel 31, and thus, favorable solidification growth is enabled.

Moreover, since the dissolution vessel 31 and the cooling means 21 are not in contact with each other, the inner bottom surface of the dissolution vessel 31 is also heated to a silicon melting point (1414° C.) or higher. Thus, occurrence of scull can be suppressed, and a contact surface between the molten silicon and the dissolution vessel 31 can also be solidified and refined.

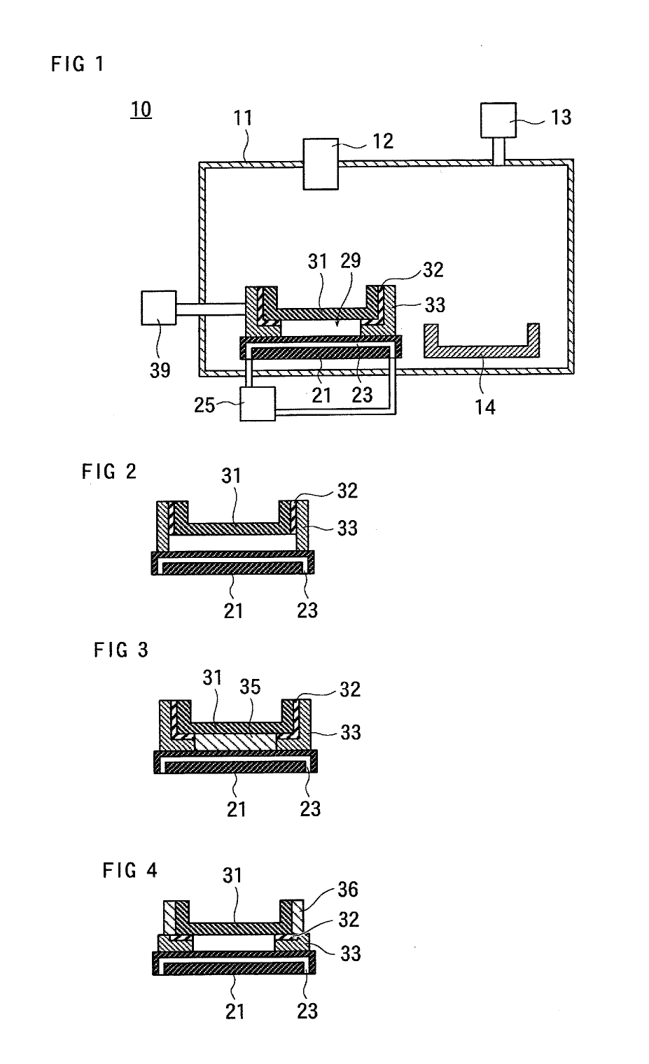

As illustrated in FIG. 2, a space between the dissolution vessel 31 and the cooling means 21 may be used as a part of the internal space of the vacuum chamber 11 so that the whole portion of the bottom surface of outer surface (that is, the outer bottom surface) of the dissolution vessel 31 faces the surface of the cooling means 21 or as illustrated in FIG. 1, the outer peripheral portion of the outer bottom surface is in contact with the first insulating material 32 and the inner portion of the portion in contact is facing the cooling means 21.

In reference to FIG. 5, an area ratio R=B/A, where (A) is an area of the inner bottom surface of the dissolution vessel 31, and (B) is a sectional area of the opening portion 29 in parallel with the inner bottom surface of the dissolution vessel 31 that is, an area of a portion in the outer bottom surface of the dissolution vessel 31 facing the surface of the cooling means 21 is preferably at least 50% and at most 200%.

In other words, a case where the area ratio R is less than 50%, the solid/liquid interface does not become horizontal and solidification cannot progress favorably in one direction toward the center in the upper surface of the dissolution vessel 31. Moreover, in a case where the area ratio R is larger than 200%, the heat removal efficiency becomes large, and the scull (those solidified without being refined remaining at the concentration of the impurities in the raw material) occurs on the bottom surface of the dissolution vessel 31.

In the above embodiment, the opening portion 29 is provided with a concentric configuration at the inner bottom surface of the dissolution vessel 31, but it is not limited in the present invention, as long as the area ratio R is at least 50% and at most 200%, and, for example, as illustrated in FIG. 6, the dissolution vessel 31 may be held by at least two columnar holding tools (supporting members) 33 in a non-contact relationship with the cooling means 21.

As illustrated in FIG. 3, between the surface on the bottom surface of the outer surface of the dissolution vessel 31 (that is, the outer bottom surface) and the surface of the cooling means 21, a second insulating material 35 in contact with both the outer bottom surface and the surface of the cooling means 21 may be arranged. The second insulating material 35 is carbon felt.

In a case where the second insulating material 35 is arranged between the outer bottom surface of the dissolution vessel 31 and the surface of the cooling means 21, the second insulating material 35 is in contact with the surface of the cooling means 21 and the outer bottom surface of the dissolution vessel 31, cooling is performed mainly by thermal conductivity of the second insulating material 35.

The heat removal efficiency of the bottom surface of the dissolution vessel 31 becomes smaller than in the case where nothing is arranged in the facing space, and the occurrence of scull on a portion in contact with the inner bottom surface of the dissolution vessel 31 can be prevented.

The outer periphery (outer side surface) of the dissolution vessel 31 may be surrounded by the first insulating material 32 sandwiched by the dissolution vessel 31 and the holding tool (supporting member) 33 as illustrated in FIGS. 1 to 3 or may be surrounded by a third insulating material 36 different from the first insulating material 32 as illustrated in FIG. 4. Here, the third insulating material 36 is not sandwiched between the dissolution vessel 31 and the holding tool (supporting member) 33.

Among outer surfaces of the dissolution vessel 31, in the case where nothing is arranged between the outer bottom surface and the surface of the cooling means 21, the bottom surface of the vessel is cooled since, in the dissolution vessel 31, the radiation emitted mainly from the bottom surface is larger than the radiation emitted from the side surfaces.

By enhancing the cooling of the bottom surface of the vessel while suppressing the cooling of side surfaces of the vessel, the silicon is solidified in one direction from the lower part to the upper part.

In the above-described embodiment, the cooling of the bottom surface of the dissolution vessel 31 by the cooling means 21 is started before the heating of the silicon by the electron beam is started, but the cooling by the cooling means 21 may be started during irradiation of the electron beam.

### Example

### Example 1

In reference to FIG. 1, the dissolution vessel 31 (depth: 60 mm, inner diameter: 300 mm) made of graphite was arranged above the cooling means 21 which surface is made of oxidized copper, and spaced from the cooling means 21. Here, emissivity of the surface of the cooling means 21 is at least 0.1.

Aluminum (Al) and iron (Fe) were added to 7.5 kg of high purified silicon (Si) so as to have a weight ratio of 250 ppm, respectively; the fabricated silicon raw material was loaded in the dissolution vessel 31; the electron beam was irradiated at irradiation density of 1000 kW/m²; and the silicon raw material was fully dissolved.

The power of the electron beam was gradually weakened without changing an irradiation width (surface) so that the solidification speed becomes 1 mm/min; and when the molten silicon located above reached 20% of the whole, the dissolution vessel 31 was tilted and the molten silicon was removed.

After the molten silicon was removed, the silicon remaining in the dissolution vessel 31 was cut out into an arbitrary size, sliced in a layered state having a 4-mm thickness in a height direction, and each was analyzed by using ICP-MS. The analysis result is shown in Table 1.

TABLE 1
Analysis Result of Example 1

| | Distance*¹ (in mm) | | | | | | | | | |
|---|---|---|---|---|---|---|---|---|---|---|
| | 2 | 6 | 10 | 14 | 18 | 22 | 26 | 30 | 34 | 38 |
| Al concentration | <0.1 | <0.1 | <0.1 | <0.1 | <0.1 | <0.1 | <0.1 | <0.1 | <0.1 | <0.1 |
| (in ppm) | | | | | | | | | | |
| Fe concentration | <0.1 | <0.1 | <0.1 | <0.1 | <0.1 | <0.1 | <0.1 | <0.1 | <0.1 | <0.1 |
| (in ppm) | | | | | | | | | | |

*¹Distance from inner bottom surface in dissolution vessel

It is found that Al and Fe which are impurities could be fully removed.

### Example 2

In reference to FIG. 3, the second insulating material 35 (carbon felt) having thermal conductivity of 0.3 W/m·K was sandwiched by the cooling means 21 and the dissolution vessel 31 made of graphite (depth: 60 mm, inner diameter: 300 mm) and arranged.

The silicon raw material fabricated by adding Al and Fe to 7.5 kg of high purified Si so as to have a weight ratio of 250 ppm, respectively, was loaded in the dissolution vessel 31; the electron beam was irradiated at irradiation density of 1000 kW/m²; and the silicon raw material was fully dissolved.

The power of the electron beam was gradually weakened without changing an irradiation width (surface) so that the solidification speed becomes 1 mm/min; and when the molten silicon reached 20% of the whole, the dissolution vessel 31 was tilted and the molten silicon was removed.

After the molten silicon was removed, the silicon remaining in the dissolution vessel 31 was cut out into an arbitrary size, sliced in a layered state having a 4-mm thickness in a height direction, and each was analyzed by using ICP-MS. The analysis result is shown in Table 2.

TABLE 2
Analysis Result of Example 2

| | Distance*² (in mm) | | | | | | | | | |
|---|---|---|---|---|---|---|---|---|---|---|
| | 2 | 6 | 10 | 14 | 18 | 22 | 26 | 30 | 34 | 38 |
| Al concentration | <0.1 | <0.1 | <0.1 | <0.1 | 0.15 | 0.23 | 5.1 | 250 | 498 | 596 |
| (in ppm) | | | | | | | | | | |
| Fe concentration | <0.1 | <0.1 | <0.1 | <0.1 | <0.1 | 0.21 | 7.9 | 98 | 523 | 498 |
| (in ppm) | | | | | | | | | | |

*²Distance from inner bottom surface in dissolution vessel

By providing the second insulating material 35 between the cooling means 21 and the dissolution vessel 31, it is found that the heat removal efficiency from the bottom surface of the dissolution vessel 31 becomes small and the occurrence of scull on a portion in contact with the inner bottom surface can be suppressed.

However, in the case where the heat removal efficiency becomes small, the temperature gradient of the solid-liquid interface becomes small. Thus, in this embodiment, it is found that constitutional undercooling occurred and the impurity concentration rapidly rose during the refining.

### Comparative Example 1

The silicon raw material fabricated by adding Al and Fe to 7.5 kg of high purified Si so as to have a weight ratio of 250 ppm, respectively, was loaded in a water-cooling copper crucible (depth: 60 mm; inner diameter: 300 mm), the electron beam was irradiated at irradiation density of 2000 kW/m²; and the silicon raw material was fully dissolved.

Here, the reason why the irradiation density of the electron beam is twice as large as those in the examples 1 and 2 is that heat removal efficiency of the water-cooling copper crucible was large and solid silicon could not be fully dissolved at a portion in contact with the inner bottom surface of the water-cooling copper crucible with the same irradiation density as those of examples 1 and 2.

The power of the electron beam was gradually weakened without changing an irradiation width (surface) so that the solidification speed becomes 1 ram/min; and when the molten silicon reached 20% of the whole, the water-cooling copper crucible was tilted and the molten silicon was removed.

After the molten silicon was removed, the silicon remaining in the water-cooling copper crucible was cut out into an arbitrary size, sliced in a layered state having a 4-mm thickness in a height direction, and each was analyzed by using ICP-MS. The analysis result is shown in Table 3.

TABLE 3
Analysis Result of Comparative Example 1

| | Distance*³ (in mm) | | | | | | | | | |
|---|---|---|---|---|---|---|---|---|---|---|
| | 2 | 6 | 10 | 14 | 18 | 22 | 26 | 30 | 34 | 38 |
| Al concentration | 10.2 | 0.32 | <0.1 | <0.1 | <0.1 | <0.1 | <0.1 | <0.1 | <0.1 | <0.1 |
| (in ppm) | | | | | | | | | | |
| Fe concentration | 10 | 0.23 | <0.1 | <0.1 | <0.1 | <0.1 | <0.1 | <0.1 | <0.1 | <0.1 |
| (in ppm) | | | | | | | | | | |

*³Distance from inner bottom surface in dissolution vessel

Since the heat removal efficiency of the water-cooling copper crucible is too large, it is found that scull occurred on a portion in contact with the inner bottom surface of the water-cooling copper crucible, and the refining efficiency was low in that portion.

### Comparative Example 2

The dissolution vessel made of graphite (depth: 60 mm, inner diameter: 300 mm) was arranged on the cooling means and in contact with the cooling means.

The silicon raw material fabricated by adding Al and Fe to 7.5 kg of high purified Si so as to have a weight ratio of 250 ppm, respectively, was loaded in the dissolution vessel; the electron beam was irradiated at irradiation density of 1000 kW/m²; and the silicon raw material was fully dissolved.

The power of the electron beam was gradually weakened without changing an irradiation width (surface) so that the solidification speed becomes 1 mm/min; and when the molten silicon reached 20% of the whole, the dissolution vessel was tilted and the molten silicon was removed.

After the molten silicon was removed, the silicon remaining in the dissolution vessel was cutout into an arbitrary size, sliced in a layered state having a 4-mm thickness in a height direction, and each was analyzed by using ICP-MS. The analysis result is shown in Table 4.

TABLE 4
Analysis Result of Comparative Example 2

| | Distance*⁴ (in mm) | | | | | | | | | |
|---|---|---|---|---|---|---|---|---|---|---|
| | 2 | 6 | 10 | 14 | 18 | 22 | 26 | 30 | 34 | 38 |
| Al concentration | 3.2 | 0.18 | <0.1 | <0.1 | <0.1 | <0.1 | <0.1 | <0.1 | <0.1 | <0.1 |
| (in ppm) | | | | | | | | | | |
| Fe concentration | 0.54 | <0.1 | <0.1 | <0.1 | <0.1 | <0.1 | <0.1 | <0.1 | <0.1 | <0.1 |
| (in ppm) | | | | | | | | | | |

*⁴Distance from inner bottom surface in dissolution vessel

In the case where the dissolution vessel is brought into direct contact with the cooling means, since the heat removal efficiency is too large, similar to the water-cooling copper crucible in the comparative example 1, it is found that scull occurred on the contact portion with the inner bottom surface of the dissolution vessel and the refining efficiency was low in that portion.

### Comparative Example 3

In reference to FIG. 1, the dissolution vessel 31 (depth: 60 mm, inner diameter: 300 mm) made of graphite was arranged above the cooling means 21 which surface is made of mirror-polished copper, and separated from the cooling means 21. By means of the mirror-polishing, the emissivity of the cooling means 21 is less than 0.1.

The silicon raw material fabricated by adding Al and Fe to 7.5 kg of high purified Si so as to have a weight ratio of 250 ppm, respectively, was loaded in the dissolution vessel 31; the electron beam was irradiated at irradiation density of 1000 kW/m²; and the silicon raw material was fully dissolved.

The power of the electron beam was gradually weakened without changing an irradiation width (surface) so that the solidification speed becomes 1 mm/min; and when the molten silicon reached 20% of the whole, the dissolution vessel 31 was tilted and the molten silicon was removed.

After the molten silicon was removed, the silicon remaining in the dissolution vessel 31 was cut out into an arbitrary size, sliced in a layered state having a 4-mm thickness in a height direction, and each was analyzed by using ICP-MS. The analysis result is shown in Table 5.

TABLE 5
Analysis Result of Comparative Example 3

| | Distance*⁵ (in mm) | | | | | | | | | |
|---|---|---|---|---|---|---|---|---|---|---|
| | 2 | 6 | 10 | 14 | 18 | 22 | 26 | 30 | 34 | 38 |
| Al concentration | <0.1 | <0.1 | <0.1 | <0.1 | <0.1 | <0.1 | 0.15 | 0.23 | 4.5 | 25 |
| (in ppm) | | | | | | | | | | |
| Fe concentration | <0.1 | <0.1 | <0.1 | <0.1 | <0.1 | <0.1 | <0.1 | 0.19 | 3.6 | 56 |
| (in ppm) | | | | | | | | | | |

*⁵Distance from inner bottom surface in dissolution vessel

Since the emissivity of the cooling means 21 is less than 0.1, radiation heat from the outer bottom surface of the dissolution vessel 31 is reflected by the cooling means 21 and the heat removal efficiency becomes low. Thus, it is found that the same phenomenon as that in example 2 occurred, and the impurity concentration rapidly rose during the refining.

### Example 3

In reference to FIG. 1, the dissolution vessel 31 (depth: 60 mm, inner diameter: 300 mm) made of graphite was arranged above the cooling means 21 which surface is made of oxidized copper, and spaced from the cooling means 21.

An area ratio R of a sectional area of the opening portion 29 in parallel with the inner bottom surface of the dissolution vessel 31 to an area of the inner bottom surface of the dissolution vessel 31 was set to a value of at least 40% and at most 200%.

The silicon raw material fabricated by adding Al and Fe to 7.5 kg of high purified Si so as to have a weight ratio of 250 ppm, respectively, was loaded in the dissolution vessel 31; the electron beam was irradiated at irradiation density of 1000 kW/m²; and the silicon raw material was fully dissolved.

The power of the electron beam was gradually weakened without changing an irradiation width (surface) so that the solidification speed becomes 1 mm/min; and when the molten silicon reached 20% of the whole, the dissolution vessel 31 was tilted and the molten silicon was removed.

After the molten silicon was removed, the silicon remaining in the dissolution vessel 31 was molten again and when the silicon was fully dissolved, 5 cc of it was taken out by a sampler and analyzed by using ICP-MS.

The area ratio R is changed within a range of at least 40% and at most 200%; and the above-described analysis test was repeated.

The analysis result is shown in Table 6.

TABLE 6
Analysis Result of Example 3

| | Ratio*⁶ (in %) | | | | | | | | | |
|---|---|---|---|---|---|---|---|---|---|---|
| | 200 | 180 | 160 | 140 | 120 | 100 | 80 | 60 | 50 | 40 |
| Al concentration | 0.12 | <0.1 | <0.1 | <0.1 | <0.1 | <0.1 | <0.1 | <0.1 | 0.35 | 0.98 |
| (in ppm) | | | | | | | | | | |
| Fe concentration | <0.1 | <0.1 | <0.1 | <0.1 | <0.1 | <0.1 | <0.1 | <0.1 | <0.1 | 0.45 |
| (in ppm) | | | | | | | | | | |

*⁶Ratio R to inner surface of dissolution vessel

It is found that, in the case where the area ratio R is less than 50%, solidification could not favorably progress in one direction toward the center in the upper surface of the dissolution vessel 31, while in the case where the area ratio R is larger than 200%, the heat removal efficiency became large and scull occurred on the bottom surface. That is, it is found that the area ratio R is preferably at least 50% and at most 200%.

### EXPLANATION OF REFERENCE NUMERALS

10. silicon refining device
11. vacuum chamber
12. heating means
21. cooling means
25. cooling device
29. opening portion
31. dissolution vessel
32. first insulating material
33. supporting member (holding tool)
35. second insulating material
36. third insulating material
39. tilting device

1. A silicon refining device, comprising:
a vacuum chamber;
cooling means arranged in the vacuum chamber;
a dissolution vessel arranged in the vacuum chamber, spaced apart from the cooling means; and
heating means to make the silicon in the dissolution vessel to melt.

2. The silicon refining device according to claim 1, further comprising:
a supporting member to hold the dissolution vessel on the cooling means, wherein
an opening portion is provided in the supporting member so that an outer bottom surface of the dissolution vessel faces the surface of the cooling means.

3. The silicon refining device according to claim 2, wherein
an area ratio of a section in parallel with the inner bottom surface of the opening portion to an inner bottom surface of the dissolution vessel is at least 50%.

4. The silicon refining device according to claim 2, wherein
a first insulating material is provided between the supporting member and the dissolution vessel.

5. The silicon refining device according to claim 4, wherein
a second insulating material is provided on the opening portion.

6. The silicon refining device according to claim 5, wherein
the first insulating material and the second insulating material are composed of carbon felt respectively.

7. A silicon refining method, comprising steps of:
arranging a base material composed of metal silicon in a dissolution vessel;
fully melting the base material arranged in the dissolution vessel in a vacuum ambience by heating the same;
solidifying the silicon from a portion where molten silicon is in contact with an inner bottom surface of the dissolution vessel by cooling a bottom surface of the dissolution vessel;
growing solidificated silicon upward; and
removing unsolidificated silicon located above the solidificated silicon from the dissolution vessel, wherein the cooling of the bottom surface of the dissolution vessel includes the step of cooling an outer bottom surface of the dissolution vessel, with the bottom surface of the dissolution vessel spaced from the cooling means and with the outer bottom surface of the dissolution vessel faced to the cooling means.

8. The silicon refining method according to claim 7, wherein
when cooling the bottom surface of the dissolution vessel, a second insulating material in contact with both the outer bottom surface of the dissolution vessel and the surface of the cooling means is arranged between the outer bottom surface of the dissolution vessel and the cooling means.

9. The silicon refining device according to claim 3, wherein
a first insulating material is provided between the supporting member and the dissolution vessel.
